(19) United States
(12) Patent Application Publication
(10) Pub. No.: US 2021/0116900 A1
(43) Pub. Date: Apr. 22, 2021

(54) Production Control System

(71) Applicant: MHP Management- und IT-Beratung GmbH, Ludwigsburg (DE)

(72) Inventors: Markus Junginger, Bad Boll (DE); Ralf Hofmann, Heilbronn (DE)

(21) Appl. No.: 17/073,429

(22) Filed: Oct. 19, 2020

(30) Foreign Application Priority Data
Oct. 17, 2019 (DE) 102019128101.6

(51) Int. Cl. G05B 19/418; G05D 1/02; G06Q 10/08

(52) U.S. Cl. CPC G05B 19/41895; G05B 19/41885; G05B 19/41865; G05D 2201/0216; G05D 1/0212; G06Q 10/087; G05B 19/4183

(57) ABSTRACT

A production control system for a matrix cell production plant (1) having an arrangement of matrix cells (2), each of which is configured to execute production processes, having logistics means which are configured to execute logistics processes and having a superordinate control logic (4) which is configured to control the matrix cells (2) and the logistics means. Proprietary data models of the matrix cells (2) and logistics means are linked via at least one ontology unit, thereby providing a continuous data flow between the matrix cells (2) and the logistics means. In dependence on the data in the data stream, production processes are automatically definable and executable in the individual matrix cells (2). Logistics processes are automatically definable and executable in individual logistics means.

### CROSS REFERENCE TO RELATED APPLICATIONS

This application claims the priority of DE 102019128101.6 filed on 2019 Oct. 17; this application is incorporated by reference herein in its entirety.

### BACKGROUND

The invention relates to a production control system.

Such production control systems are generally used to control production equipment that can be used to produce different products. The term production equipment also includes complete production plants, i.e. factories.

In more modern production plants, i.e. factories, production processes and logistics procedures are largely automated. Modern factories, so-called smart factories, are subdivided into matrix cells, i.e. flexible production cells, where the logistics processes, in particular the transport of materials between the matrix cells, are handled by logistics means in the form of autonomous driving vehicles, in particular AGVs (automated guided vehicles).

The matrix cells and an autonomous driving vehicle are controlled by a superordinate control logic. The superordinate control logic specifies in particular the production processes to be executed with the matrix cells. In addition, the autonomous driving vehicles are controlled by the superordinate control logic. For this purpose, the superordinate control logic specifies a chronological sequence of production processes to be processed with the matrix cells. In dependence on this, the superordinate control logic determines when which matrix cells are approached by autonomous driving vehicles, for example to supply them with material.

### SUMMARY

The invention relates to a production control system for a matrix cell production plant (1) having an arrangement of matrix cells (2), each of which is configured to execute production processes, having logistics means which are configured to execute logistics processes and having a superordinate control logic (4) which is configured to control the matrix cells (2) and the logistics means. Proprietary data models of the matrix cells (2) and logistics means are linked via at least one ontology unit, thereby providing a continuous data flow between the matrix cells (2) and the logistics means. In dependence on the data in the data stream, production processes are automatically definable and executable in the individual matrix cells (2). Logistics processes are automatically definable and executable in individual logistics means.

### DETAILED DESCRIPTION

The object of the invention is to increase the functionality of a production control system of the type mentioned above.

The features of the independent claims are intended to provide a solution to this object. Advantageous embodiments and appropriate further developments of the invention are described in the dependent claims.

The invention relates to a production control system for a matrix cell production plant having an arrangement of matrix cells, each of which is configured to execute production processes, having logistics means which are configured to execute logistics processes and having a superordinate control logic which is configured to control the matrix cells and the logistics means. Proprietary data models of the matrix cells and logistics means are linked via at least one ontology unit, thereby providing a continuous data flow between the matrix cells and the logistics means. In dependence on the data in the data stream, production processes are automatically definable and executable in the individual matrix cells. Logistics processes are automatically definable and executable in individual logistics means.

The invention further relates to a method for controlling a matrix cell production plant.

In the production control system according to the invention, a superordinate control logic is provided, which is configured to control production processes executed with individual matrix cells and logistics processes executed with logistics means.

According to the invention, the functionality of such a production control system is extended in that the matrix cells and the logistic means as local units are themselves equipped with their own intelligence such that they can define and execute processes automatically, i.e. without receiving instructions or control commands from the superordinate control logic. A matrix cell can automatically define production processes executable on it and also execute these production processes automatically. Correspondingly, logistics means can define and execute logistics processes automatically.

On the one hand, this distributed intelligence reduces the load of the superordinate control logic. The superordinate control logic no longer has to specify all processes of the matrix cell and logistics means itself, such that its required computing effort is reduced and the requirements regarding the structure and capacity of the superordinate control logic can be kept low.

On the other hand, local matrix cells and logistics means can optimize their functions and utilization in dependence on their current state and also in dependence on planned processes. Interactions with other matrix cells and logistics means can also be included in these optimizations.

These optimizations generally are carried out in dependence on the control processes defined by the superordinate control logic, such that the local optimization processes in the matrix cells and logistics means do not collide with the control processes specified by the superordinate control logic. Furthermore, optimizations in individual matrix cells or logistic means are carried out in dependence on the states of other matrix cells and logistic means, such that the matrix cells and logistic means work collision-free among themselves.

According to an advantageous embodiment, the superordinate control logic is configured to define production specifications. In dependence on these, production processes are automatically generated in the matrix cells and/or logistics processes are automatically generated in the logistics means.

In this case, the superordinate control logic defines superordinate control commands by defining production specifications. In dependence on these superordinate control commands, the matrix cells automatically generate production processes and the logistics means automatically generate logistics processes, which are advantageously controlled and monitored by the superordinate control logic. In the event of impending collisions, for example, production processes of individual matrix cells and logistics processes of individual logistics means can then be selectively and time-dependently interrupted and only released at later points in time.

It is particularly advantageous that the automatic generation of production processes in the matrix cells and/or logistics processes in the logistics means is carried out in dependence on the process and resource availabilities of matrix cells and/or logistics means.

In this way, an optimization of the utilization of the individual matrix cells and logistics means can be achieved.

In particular, periods of process and resource availabilities are taken into account.

This enables anticipatory planning and optimization of processes.

It is further advantageous that the automatic generation of production processes in the matrix cells and/or logistics processes in the logistics means is carried out in dependence on production costs.

In particular, in can be decided in cost-optimized fashion which matrix cells should carry out production processes at what times and which logistics means should carry out logistics processes at what times. These decisions can be made, for example, in dependence on the energy costs of the processes executed with the individual matrix cells or logistics means.

According to an advantageous embodiment, the logistic means are formed as autonomous driving vehicles.

In particular, such autonomous driving vehicles can be configured as AGVs (automated guided vehicles).

In this case, a selection of matrix cells to be approached can be advantageously specified as a logistics process generated automatically in an autonomous driving vehicle.

The autonomous driving vehicle thus automatically selects the matrix cell(s) to be supplied with materials, for example.

According to another advantageous embodiment, a sequence of matrix cells to be approached can be specified as a logistics process generated automatically in an autonomous driving vehicle.

For the production of a specific part or a unit consisting of several parts, the superordinate control logic can define a sequence of production processes which is entered into an autonomous driving vehicle as logistics means. The autonomous driving vehicle then automatically drives to matrix cells one by one, where this sequence of production processes is executed. The autonomous driving vehicle thus automatically searches for a path through the matrix cell production plant and selects suitable matrix cells, wherein the free resources of the individual matrix cells can be taken into account in this selection. Furthermore, as a boundary condition for this selection, the production costs, in particular the energy costs, which are incurred during the execution of production processes with individual matrix cells, can be taken into account.

According to a further embodiment of the invention, matrix cells are configured for the production of parts.

In this case, the production of spare parts is provided as the production process automatically generated in a matrix cell.

In this case, the superordinate control logic again specifies production specifications, in dependence on which specific parts are produced with a matrix cell, which are used to complete ordered products. The respective matrix cell then uses times in which it is not being fully utilized to produce spare parts that are not scheduled in the production of the products. For this purpose, the respective matrix cell itself defines the corresponding production processes for the production of the spare parts. The scope of the produced spare parts can be defined in the matrix cell in dependence on economic boundary conditions such as storage capacities, material availability and the like.

According to an advantageous embodiment, automatically generated production processes and/or logistics processes are definable by means of simulation methods.

The simulation is preferably carried out in dependence on specified boundary conditions such as specific production specifications or economic boundary conditions such as production costs.

As a result of the simulation, time-dependent optimizations for the type and scope of production processes that can be initiated automatically in matrix cells and logistics processes that are generated automatically in logistics means can be carried out. The results obtained in the simulation for such production and logistics processes can then be implemented in real production processes.

According to another advantageous embodiment, the matrix cell production plant is integrated into a cloud computer network.

The matrix cell production plant can then be extended to spatially distributed systems which are connected via a cloud. Here it is advantageous that in local subunits of the distributed matrix cell production plants automatic production processes can be generated in the matrix cells and automatic logistics processes in the logistics means, such that these local subunits each form systems with local intelligence.

An essential prerequisite for the functionality of the production control system according to the invention is the networking of the components, in particular of the matrix cells and logistics means with each other, such that a standardized, continuous data stream exists between them.

According to the invention, for this purpose at least one ontology unit carries out a semantic networking of all different proprietary data models of the individual units of the matrix cell production plant, in particular of all matrix cells and logistics means.

This enables a continuous exchange of information between all proprietary data models without having to provide individual interfaces at a system level. Rather, the semantic networking achieved with the ontology unit enables the data models to be mapped in a comprehensive digital model, a so-called digital twin, by means of which a bidirectional harmonizing data stream between all units of a production facility is made possible without additional hardware expenses at a system level. In particular, completely different proprietary data models from the areas of product development, production and logistics can be networked.

According to an advantageous embodiment, the ontology unit provides ontology-forming class structures, which have classes structured in hierarchies or groups, by means of which a semantic networking of the proprietary data models is feasible.

Advantageously the ontologies are described by means of standard protocols, such as an RDF (Resource Description Framework).

### BRIEF DESCRIPTION OF THE DRAWINGS

The invention is explained below on the basis of the drawings. The drawings show:

FIG. 1: A schematic representation of an embodiment example of the matrix cell production plant according to the invention.

FIG. 2: A block diagram of a production control system for the matrix cell production plant as shown in FIG. 1.

FIG. 3: An embodiment example for the automatic generation of logistic processes of logistic means configured as an autonomous driving vehicle.

### DETAILED DESCRIPTION OF THE PREFERRED EMBODIMENTS

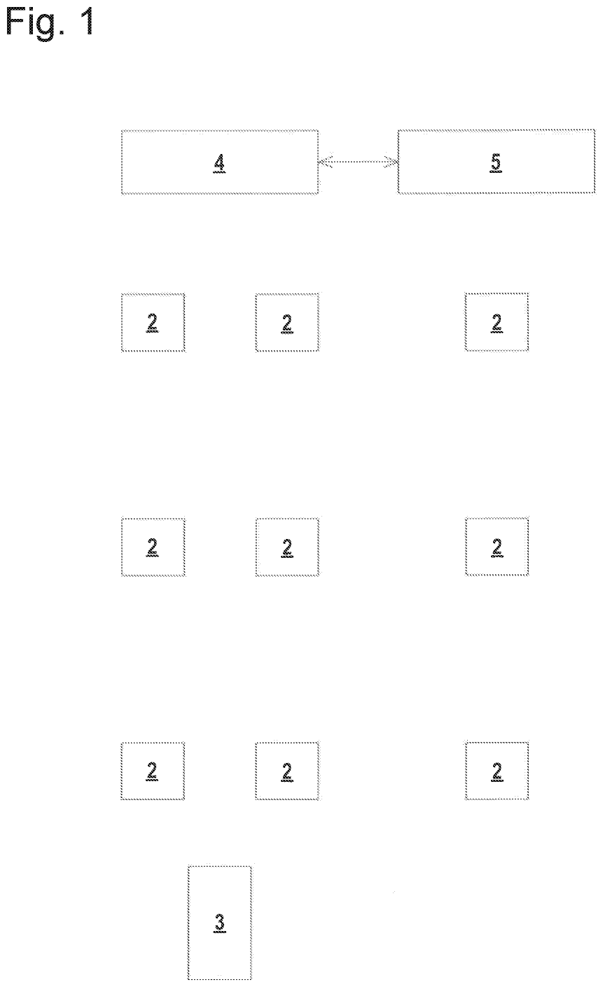

FIG. 1 schematically shows the structure of a matrix cell production plant 1, which may be installed in a factory, for example. In general, the matrix cell production plant 1 may also be distributed over several locations, where these may be used in particular for the production of motor vehicles.

The matrix cell production plant 1 features a multiple arrangement of individual matrix cells 2, which on the basis of their specific configuration are configured to execute different production processes. In this context, the term production process generally includes machining processes of parts, assembly processes, but also positioning or provisioning processes. Each matrix cell 2 has a computer unit that is not shown.

The matrix cell production plant 1 also has a number of logistic means that are configured to execute logistic processes. In the present case, the logistic means are formed by autonomous driving vehicles 3, preferably AGVs (automated guided vehicles). Every autonomous driving vehicle has a computer unit that is not shown.

With the autonomous driving vehicles 3 logistics processes can be executed in such a way that materials can be supplied to or collected from individual matrix cells 2.

For the sake of clarity, FIG. 1 shows only one autonomous driving vehicle 3.

For the central control of the matrix cells 2 and logistic means, a superordinate control logic 4 is provided, which is configured, for example, in the form of neural networks.

A computer system 5 on which a business management software is implemented is assigned to the superordinate control logic 4. The superordinate control logic 4 can read business data from the computer system 5 for control purposes.

All units of the matrix cell production plant 1, i.e. the superordinate control logic 4, the computer system 5, the matrix cells 2 as well as the autonomous driving vehicles 3 are coupled with each other via preferably contactless data interfaces, such that they can exchange data among each other.

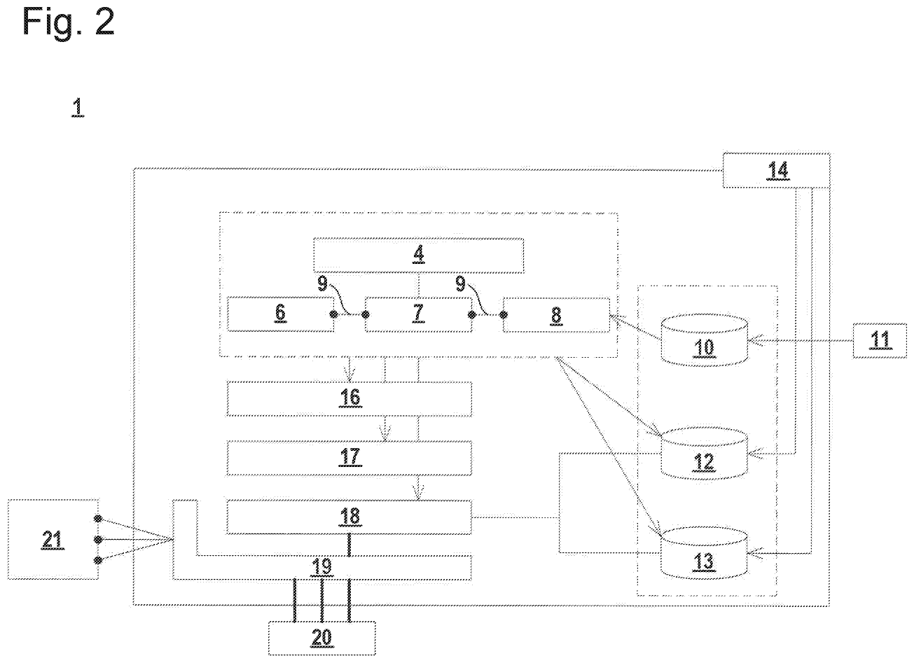

FIG. 2 shows an example of a production control system for the matrix cell production plant 1 according to FIG. 1.

According to the invention, the production control system has an arrangement of ontology units by means of which proprietary data models of the manufacturer-specific matrix cells 2 and logistics means and also product facility-specific data and processes are semantically networked.

As FIG. 2 shows, a resource unit 6, a process unit 7 and a product unit 8, which are controlled by the superordinate control logic 4, are provided as ontology units. These ontology units form a virtual model of the processes carried out in the production facility.

In the individual ontology units ontology-forming object models are provided, which are linked with each other via suitable ontological links 9 and thus manage a semantic networking of proprietary data models existing in the resource unit 6, the process unit 7 and the product unit 8.

In the resource unit 6, ontologies are used to structure and digitally make available data that describe and define production processes. The data form production-specific proprietary data models, which are integrated via ontologies into a harmonized data stream that can flow across all units of the production facility.

The production sequences generally include not only production processes but also logistics processes.

In the process unit 7, specific production processes for production or work means such as robots are programmed in an executable program code (e.g. in a PLC code) in dependence on data from proprietary data models of the resource unit 6 and the product unit 8. The ontologies enable a harmonizing data stream between the process unit 7 and the resource unit 6 and the product unit 8 without having to provide interfaces for that purpose at a system level.

Product data 10 are provided and made available in the product unit 8. As FIG. 2 shows, in dependence on external, customer-specific product specifications 11 product data 10 are made available to the product unit 8 in proprietary data modules, for example as CAD data.

These product data 10 are processed and made available in the product unit 8. In particular, the product data 10 are stored permanently, preferably non-volatilely, as persistence data 12 in a working memory as unchangeable storage means.

Furthermore, using the ontologies of the product unit 8, digital models are generated from the product data 10, which are stored as so-called digital twins 13. The persistence data 12 and the digital twins 13 can be analyzed by means of an analysis unit 14.

On the whole, the resource unit 6, the process unit 7 and the product unit 8 form an ontology model with which all proprietary data models of the matrix cell production plant 1 are semantically networked, such that a standardized, harmonic data stream of all data of the overall system is achieved between all units of the matrix cell production plant 1, without the need to use physical interfaces at a system level to adapt data to be transmitted.

The resource unit 6 is used to prepare proprietary data from machine manufacturers who supply and provide work or production means such as processing machines and logistics means such as AGVs with defined functionalities.

The product unit 8 is used to prepare and provide customer-specific proprietary product data 10.

Finally, in the process unit 7 proprietary data are also generated by process designers by generating there executable program codes for production and logistics means.

The data and programs generated in the resource unit 6, the process unit 7 and the product unit 8 are fed to a validation layer 16 and a programming layer 17.

A check and validation of created program codes is performed in the validation layer 16. In particular, commissioning is carried out by checking whether the programmed processes are feasible, in particular whether they are collision-free.

After successful validation, machine codes for the production and work means are generated using the programming layer 17.

A normalization layer 18 is provided as a further component of the ontology model according to the invention. There, program code written in high-level languages is translated into application software such as PLC software.

Finally, an adapter layer 19 is provided, which establishes the connection to communication units 20 such as mail, internet and the like. In addition, the adapter layer 19 is used to establish connections with external units 21 of suppliers, partner companies and the like.

According to the invention, the standardized data stream generated with the ontologies between the individual units of the matrix cell production plant 1 is used to enable the individual matrix cells 2 to define and execute production processes automatically, and to enable the logistics means, i.e. the autonomous driving vehicles 3, to define and execute logistics processes automatically.

Appropriately, the superordinate control logic 4 is configured to define production specifications. In dependence on these, production processes are automatically generated in the matrix cells 2 and/or logistics processes are automatically generated in the logistics means.

In this context, the superordinate control logic 4 is advantageously configured to monitor compliance with the production specifications.

The automatic generation of production processes in the matrix cells 2 and/or logistics processes in the logistics means is carried out advantageously in dependence on the process and resource availabilities of matrix cells 2 and/or logistics means.

Furthermore, periods of process and resource availabilities can be taken into account.

The business management software provides business data concerning the production costs.

Such an intelligent machine behavior can be applied, for example, to matrix cells 2, which are configured for the production of parts.

The superordinate control logic 4 specifies production specifications according to which these matrix cells 2 must produce a specified number of parts at specified times, which are then needed in the production process.

However, the matrix cell 2 does not have to continuously produce parts for the production process and thus has several downtimes.

According to the invention, the matrix cell 2 automatically defines production processes in such a way that it produces spare parts that are not needed for the current production process. The execution of these production processes, i.e. the production of the spare parts, is carried out in controlled fashion locally at the matrix cell 2 during its downtimes.

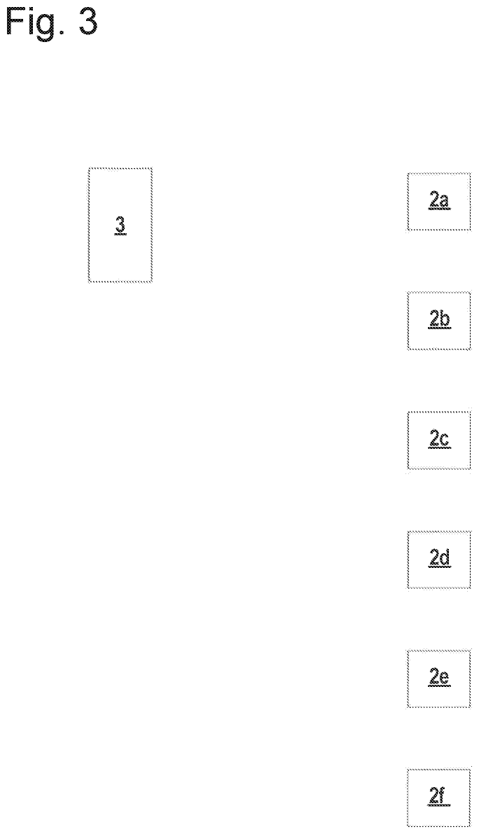

FIG. 3 shows another example of intelligent machine behavior. There, an autonomous driving vehicle 3 is assigned to a series of matrix cells 2a-2f, which can carry out different production processes, for example different machining of parts or different positioning of parts.

Logistics processes can now be generated automatically in the autonomous driving vehicle 3. A logistics process consists of a specific sequence of production processes executed with all or part of the matrix cells 2a-2f. According to the defined logistics processes, the autonomous driving vehicle 3 then automatically drives to the matrix cells 2a-2f, such that the production processes can be executed there in the specified sequence.

### LIST OF REFERENCE NUMERALS

(1) Matrix cell production plant
(2) Matrix cell
(3) Autonomous driving vehicle
(4) Superordinate control logic
(5) Computer system
(6) Resource unit
(7) Process unit
(8) Product unit
(9) Link
(10) Product data
(11) Product specification
(12) Persistence data
(13) Digital twin
(14) Analysis unit
(16) Validation layer
(17) Programming layer
(18) Normalization layer
(19) Adapter layer
(20) Communication unit
(21) External unit

1. A production control system for a matrix cell production plant (1), having an arrangement of matrix cells (2), each of which is configured to execute production processes, having logistics means, which are configured to execute logistics processes, and having a superordinate control logic (4), which is configured to control the matrix cells (2) and the logistics means, characterized in that proprietary data models of the matrix cells (2) and logistics means are linked via at least one ontology unit, as a result of which a continuous data stream is obtained between the matrix cells and the logistics means, and in that, in dependence on data of the data stream, production processes are automatically definable and executable in individual matrix cells (2) and/or logistics processes are automatically definable and executable in individual logistics means.

2. The production control system according to claim 1, characterized in that the superordinate control logic (4) is configured to define production specifications, and in that, in dependence on these, production processes are automatically generated in the matrix cells (2) and/or logistics processes are automatically generated in the logistics means.

3. The production control system according to claim 2, characterized in that the superordinate control logic (4) is configured to monitor compliance with the production specifications.

4. The production control system according to claim 1, characterized in that the automatic generation of production processes in the matrix cells (2) and/or logistics processes in the logistics means is carried out in dependence on process and resource availabilities of matrix cells (2) and/or logistics means.

5. The production control system according to claim 4, characterized in that periods of process and resource availabilities are taken into account.

6. The production control system according to claim 1, characterized in that the automatic generation of production processes in the matrix cell (2) and/or logistics processes in the logistics means is carried out in dependence on production costs.

7. The production control system according to claim 1, characterized in that the logistic means are formed by autonomous driving vehicles (3).

8. The production control system according to claim 7, characterized in that a selection of matrix cells (2) to be approached is specifiable as a logistics process automatically generated in an autonomous driving vehicle (3).

9. The production control system according to claim 7, characterized in that a sequence of matrix cells (2) to be approached is specifiable as a logistics process automatically generated in an autonomous driving vehicle (3).

10. The production control system according to claim 1, characterized in that matrix cells (2) are configured for the production of parts.

11. The production control system according to claim 7, characterized in that the production of spare parts is provided as a production process automatically generated in a matrix cell (2).

12. The production control system according to claim 1, characterized in that automatically generatable production processes and/or logistics processes are definable by means of simulation methods.

13. The production control system according to claim 12, characterized in that the utilization rates of matrix cells (2) and logistics means are optimizable by means of the simulation methods.

14. The production control system according to claim 1, characterized in that the matrix cell production plant (1) is integrated into a cloud computer network.

15. A method for controlling a matrix cell production plant (1), having an arrangement of matrix cells (2), each of which is configured to execute production processes, having logistics means, which are configured to execute logistics processes, and having a superordinate control logic (4), which is configured to control the matrix cell (2) and the logistics means, characterized in that proprietary data models of the matrix cells (2) and logistics means are linked via at least one ontology unit, as a result of which a continuous data stream is obtained between the matrix cells (2) and the logistics means, and in that, in dependence on data of the data stream, production processes are automatically definable and executable in individual matrix cells (2) and/or logistics processes are automatically definable and executable in individual logistics means.
